(19) United States
(12) Patent Application Publication
(10) Pub. No.: US 2025/0121880 A1
(43) Pub. Date: Apr. 17, 2025

(54) VEHICLE CONTROL DEVICE, VEHICLE CONTROL METHOD, AND STORAGE MEDIUM

(71) Applicant: HONDA MOTOR CO., LTD., Tokyo (JP)

(72) Inventors: Nozomu Hirosawa, Tokyo (JP); Takuya Tobe, Tokyo (JP); Daichi Kato, Tokyo (JP)

(21) Appl. No.: 18/908,858

(22) Filed: Oct. 8, 2024

(30) Foreign Application Priority Data
Oct. 13, 2023 (JP) 2023-177793

(51) Int. Cl. B62D 6/00; B60W 60/00

(52) U.S. Cl. CPC B62D 6/00; B60W 60/001

(57) ABSTRACT

A vehicle control device includes a deviation suppression controller configured to suppress deviation of a vehicle from a traveling lane along which the vehicle travels, and a lane change controller configured to perform lane change control of causing the vehicle to change a lane from the traveling lane to a lane adjacent to the traveling lane, and the deviation suppression controller suppresses deviation of the vehicle from the traveling lane when the vehicle has moved in a direction opposite to the adjacent lane regardless of an operation of an occupant in the vehicle after the lane change control is started.

### CROSS-REFERENCE TO RELATED APPLICATION

Priority is claimed on Japanese Patent Application No. 2023-177793, filed Oct. 13, 2023, the content of which is incorporated herein by reference.

### BACKGROUND OF THE INVENTION

### Field of the Invention

The present invention relates to a vehicle control device, a vehicle control method, and a storage medium.

### Description of Related Art

In recent years, efforts to provide access to sustainable transportation systems that take into consideration the most vulnerable traffic participants have been more active. To achieve this, research and development into automatic driving technology is being focused on to further improve transportation safety and convenience. In relation to this, technology is known that enables autonomous lane changes in response to simple driver operations. Japanese Unexamined Patent Application, First Publication No. 2018-203121, discloses that when making an autonomous lane change, if the driver's steering exceeds the override threshold, the automatic lane change is canceled.

### SUMMARY OF THE INVENTION

However, with conventional technology, there was a concern that it would not be possible to respond to events that were not dependent on the driver's operation.

An aspect of the present invention is directed to providing a vehicle control device, a vehicle control method, and a storage medium that are capable of responding appropriately when an event occurs that is not dependent on a driver's operation. This aspect of the present invention contributes to development of a sustainable transportation system.

A vehicle control device, a vehicle control method, and a storage medium according to the present invention employ the following configurations.
(1) A vehicle control device according to an aspect of the present invention includes a deviation suppression controller configured to suppress deviation of a vehicle from a traveling lane along which the vehicle travels; and a lane change controller configured to perform lane change control of causing the vehicle to change a lane from the traveling lane to a lane adjacent to the traveling lane, and the deviation suppression controller suppresses deviation of the vehicle from the traveling lane when the vehicle moves in a direction opposite to the adjacent lane regardless of an operation of an occupant in the vehicle after the lane change control has been started.
(2) In the aspect of the above-mentioned (1), the deviation suppression controller is set to an OFF state when the lane change control has been started, and is set to an ON state when the vehicle moves in the opposite direction with respect to the adjacent lane after the lane change control has been started, regardless of the operation of the occupant in the vehicle.
(3) In the aspect of the above-mentioned (1), the deviation suppression controller is set to an OFF state when the lane change control has been started, and is maintained in the OFF state when the vehicle moves to the adjacent lane after the lane change control has been started.
(4) In the aspect of the above-mentioned (1), the deviation suppression controller becomes in the ON state when the vehicle reaches a road division line in the opposite direction to the adjacent lane, regardless of the operation of the occupant in the vehicle, after the lane change control has been started.
(5) In the aspect of the above-mentioned (1), the lane change control is canceled when a predetermined time elapses from a starting time point or the vehicle has moved a predetermined distance, and the deviation suppression controller becomes an ON state from an OFF state when the lane change control has been canceled.
(6) In the aspect of the above-mentioned (1), the lane change control is a control in which steering control of the vehicle is started at a timing after a reference time has been elapsed from a timing when a starting condition has been established, and the deviation suppression controller suppresses deviation of the vehicle from the traveling lane when the vehicle has moved in the opposite direction with respect to the adjacent lane regardless of an operation of an occupant in the vehicle until a reference time elapses from a timing when a starting condition of the lane change control was established.
(7) In aspect of the above-mentioned (1), when the lane change control is not performed, the deviation suppression controller suppresses deviation of the vehicle from the traveling lane with respect to road division lines on both sides of the traveling lane, and when the lane change control is performed, the deviation suppression controller suppresses the deviation of the vehicle from the traveling lane with respect to the road division line in the opposite direction to the adjacent lane among the road division lines on both sides of the traveling lane.
(8) In aspect of the above-mentioned (1), the lane change controller operates a direction indicator when the lane change control is performed, and after the lane change control has been started and when the deviation suppression controller suppresses the deviation of the vehicle from the traveling lane as the vehicle moves in the opposite direction to the adjacent lane, regardless of an operation of an occupant in the vehicle, the operation of the direction indicator is stopped.
(9) A vehicle control method according to another aspect of the present invention causes a vehicle control device to execute: processing of performing lane change control of causing a vehicle to autonomously change a lane from a traveling lane along which the vehicle travels to a lane adjacent to the traveling lane; and processing of suppressing deviation of the vehicle from the traveling lane when the vehicle moves in an opposite direction with respect to the adjacent lane, regardless of an operation of an occupant in the vehicle, after the lane change control has been started.
(10) A computer-readable non-transient storage medium on which program is stored according to another aspect of the present invention to cause a processor of a vehicle control device to execute: processing of performing lane change control of causing a vehicle to autonomously change a lane from a traveling lane along which the vehicle travels to a lane adjacent to the traveling lane; and processing of suppressing deviation of the vehicle from the traveling lane when the vehicle moves in an opposite direction with respect to the adjacent lane, regardless of an operation of an occupant in the vehicle, after the lane change control has been started.

### Advantageous Effects of the Invention

According to the aspects of the above-mentioned (1) to (10), it is possible to respond appropriately when an event occurs that is not dependent on the driver's operation.

### BRIEF DESCRIPTION OF THE DRAWINGS

FIG. 1 is a view showing an example of a configuration and a usage environment of a vehicle control device.

FIG. 2 is a view showing an example of a relationship between a distance between a reference point of a vehicle and a road division line, and a force in which a deviation suppression controller causes an actuator to output according to the distance.

FIG. 3 is a view showing an example of a flow of processing executed by a lane change controller of a first embodiment.

FIG. 4 is a view showing an example of an operation in a comparative example having no function of the present invention.

FIG. 5 is a view showing an example of an operation in the vehicle control device of the first embodiment.

FIG. 6 is a view showing an example of a flow of processing executed by a lane change controller of a second embodiment.

### DETAILED DESCRIPTION OF THE INVENTION

Hereinafter, embodiments of a vehicle control device, a vehicle control method, and a storage medium of the present invention will be described with reference to the accompanying drawings.

### First Embodiment

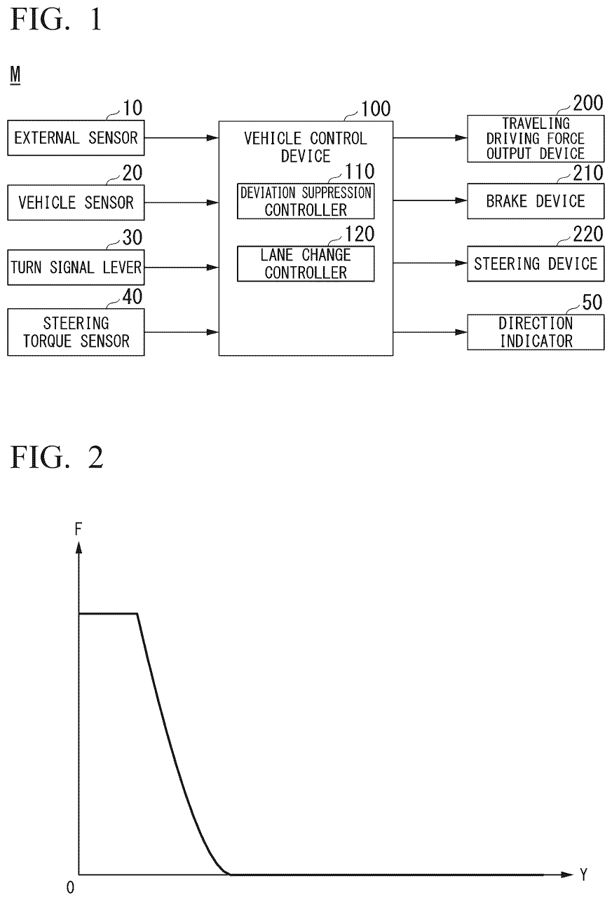

FIG. 1 is a view showing an example of a configuration and a usage environment of a vehicle control device 100. In a vehicle M in which the vehicle control device 100 is mounted, for example, an external sensor 10, a vehicle sensor 20, a turn signal lever 30, a steering torque sensor 40, a direction indicator 50, the vehicle control device 100, a traveling driving force output device 200, a brake device 210, a steering device 220, and the like, are mounted. The vehicle M may also be equipped with other components that are naturally provided in a typical vehicle (such as an accelerator pedal, a brake pedal, or the like), but the following description will focus on the components related to the present invention.

The external sensor 10 may include some or all of the following, for example, a radar device, a camera, a light detection and ranging (LIDAR), a sensor fusion device, and the like. These devices have a detection range around (outside) the vehicle M, and output information (signals, images, coordinates, and the like) indicating objects present around the vehicle M to the vehicle control device 100.

The vehicle sensor 20 is a speed sensor, an acceleration sensor, a yaw rate sensor, an orientation sensor, or the like. The vehicle sensor 20 outputs a detection result to the vehicle control device 100.

The turn signal lever 30 is an operator that can be indicated and operated to either the left or the right. The turn signal lever 30 is an operator configured to activate the direction indicator and also has a function of accepting a start request for lane change control. For example, the turn signal lever 30 is capable of accepting multiple stages of operations with different operation amounts, and is configured so that when a predetermined stage of operation is performed, a start request for lane change control is output to the vehicle control device 100 rather than simply operating the direction indicator 50.

The steering torque sensor 40 detects the operating force applied to the steering wheel (steering operator) by the driver and outputs the detection result to the vehicle control device 100.

The direction indicator 50 includes a plurality of lamps provided on the exterior part of the vehicle M. The direction indicator 50 is controlled by the vehicle control device 100 or a dedicated control device (not shown) so that a lamp provided in the direction in which the turn signal lever 30 is operated blinks. In addition, the direction indicator 50 is controlled by the vehicle control device 100 so that, while lane change control is being executed, the lamp provided in the direction in which the vehicle M is to autonomously change lanes blinks.

A function and a configuration of the vehicle control device 100 will be described below.

The traveling driving force output device 200 outputs the traveling driving force (torque) to the driving wheels so that the vehicle M travels. The traveling driving force output device 200 includes a combination of, for example, an internal combustion engine, a traveling motor, and a gearbox, as well as an electronic control unit (ECU) that controls these. The ECU controls the above-mentioned components according to the information input from a control device 100 or the information input from a driving operator (not shown).

The brake device 210 includes, for example, a brake caliper, a cylinder configured to transmit a hydraulic pressure to the brake caliper, an electric motor configured to generate a hydraulic pressure in the cylinder, and a brake ECU. The brake ECU controls the electric motor according to information input from the control device 100 or information input from the driving operator so that the brake torque corresponding to the braking operation is output to each wheel. The brake device 210 may include a mechanism configured to transmit the hydraulic pressure generated by the operation of the brake pedal included in the driving operator to the cylinder via a master cylinder as a backup. In addition, the brake device 210 is not limited to the configuration described above, but may be an electronically-controlled hydraulic brake device that controls the actuator according to the information input from the control device 100 and transmits the hydraulic pressure from the master cylinder to the cylinder.

The steering device 220 includes, for example, a steering ECU, and an electric motor. The electric motor applies, for example, a force to a rack and pinion mechanism to change the direction of the steered wheel. The steering ECU drives the electric motor and changes the direction of the steered wheels according to the information input from the control device 100 or the information input from the driving operator.

The vehicle control device 100 includes, for example, a deviation suppression controller 110, and a lane change controller 120. These components are realized by one or more hardware processors, such as a central processing unit (CPU) or the like, executing programs (software). Some or all of these components may be realized by hardware (circuit part; including circuitry) such as large scale integration (LSI), an application specific integrated circuit (ASIC), a field-programmable gate array (FPGA), a graphics processing unit (GPU), or the like, or may be realized by cooperation of software and hardware. The program may be stored in advance on a storage device (a storage device with a non-transitory storage medium) such as a hard disk drive (HDD), a flash memory, or the like, or it may be stored on a removable storage medium (non-transitory storage medium) such as a DVD, a CD-ROM, or the like, and installed by inserting the storage medium into a drive device. The vehicle control device 100 may have a plurality of processors operating in a distributed environment.

One or both of the deviation suppression controller 110 and the lane change controller 120, or a functional part of the vehicle control device 100 other than these, has a function of recognizing the surrounding environment of the vehicle M based on the output of the external sensor 10 (hereinafter referred to as “a recognition part”). The recognition part recognizes a position of an object around the vehicle M, as well as its state such as speed and acceleration, and the like. The position of the object is recognized as, for example, a position on absolute coordinates with the representative point of the vehicle M (such as the center of gravity or the center of the driving shaft) as the origin, and is used for control. The position of the object may be expressed as a representative point such as the center of gravity or a corner of the object, or as an area. The “state” of the object may include the acceleration of the object, jerk, or “behavioral state” (for example, whether it is making or about to make a lane change).

In addition, the recognition part recognizes, for example, the lane in which the vehicle M is traveling (traveling lane), the adjacent lanes adjacent to the traveling lane, and the road division lines that divide them. For example, the recognition part recognizes the traveling lanes by comparing a pattern of the road division line (for example, arrangements of solid and dashed lines) obtained from the map information with a pattern of the road division line around the vehicle M recognized from the image captured by the camera. Further, the recognition part may recognize a traveling lane by recognizing runway boundaries (road boundaries), including not only road division lines but also road division lines, shoulders, curbs, median strips, guardrails, or the like. When the recognition part recognizes a traveling lane, it recognizes the position or the posture of the vehicle M relative to the traveling lane. The recognition part may, for example, recognize the separation from the lane center of the reference point of the vehicle M and the angle of the direction of advance of the vehicle M with respect to the line connecting the lane centers, as a relative position and posture of the vehicle M with respect to the traveling lane. Alternatively, the recognition part may recognize the position of the reference point of the vehicle M with respect to any side end portion (road division line or road boundary) of the traveling lane as the relative position of the vehicle M with respect to the traveling lane.

The deviation suppression controller 110 performs control of suppressing deviation of the vehicle M from the traveling lane. For example, the deviation suppression controller 110 causes the steering device 220 to output a steering force or an operation reaction force with respect to the steering wheel in a direction opposite to the road division line as the distance between the reference point of the vehicle M (a position of the wheel closest to the road division line or the like) and the road division line is reduced. FIG. 2 is a view showing an example of a relationship between a distance between the reference point of the vehicle M and the road division line and a force in which the deviation suppression controller 110 causes the actuator to output according to the distance. In the drawings, Y indicates the distance between the reference point of the vehicle M and the road division line, and F indicates a force output to the actuator.

The lane change controller 120 starts lane change control when a driver performs a predetermined operation (starting operation) with respect to the turn signal lever 30, in a case in which the following conditions are satisfied (when a starting trigger of the lane keeping control occurs): (1) another vehicle is not present in an area including a side of the vehicle M in the adjacent lane corresponding to a direction in which the operation is performed, (2) a speed of the vehicle M is within a fixed range (for example, about 60 to 100 [km/h]), (3) lane keeping control (control of assisting the vehicle to travel a center of the traveling lane, unlike the control of the deviation suppression controller 110) is performed by the vehicle control device, and the like. When the lane change control is started, the lane change controller 120 controls the steering device 220 so as to output a steering force for causing the vehicle M to autonomously change lanes after waiting for the reference time to elapse. Here, the lane change controller 120 instructs the traveling driving force output device 200 so as to maintain the speed of the vehicle M at a desired speed.

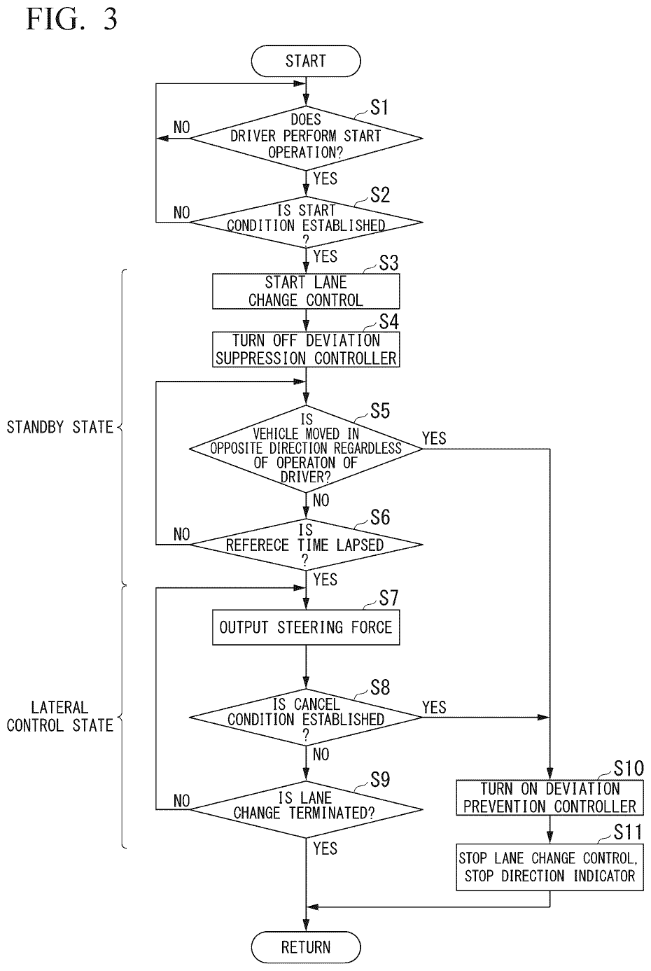

FIG. 3 is a view showing an example of a flow of processing executed by the lane change controller 120 of the first embodiment. First, the lane change controller 120 determines whether a driver performs a starting operation with respect to the turn signal lever 30 (step S1). When it is detected that the driver performs a starting operation with respect to the turn signal lever 30, the lane change controller 120 determines whether the initiation condition of the lane change control is established (step S2). If a negative determination result is obtained in either step S1 or step S2, the processing is returned to step S1. Further, when the turn signal lever 30 is started, the direction indicator 50 starts to operate in tandem.

When the initiation condition of the lane change control is established, the lane change controller 120 starts the lane change control (step S3). In addition, the lane change controller 120 instructs the deviation suppression controller 110 to turn OFF (step S4). Further, such processing may be performed autonomously by the deviation suppression controller 110 by monitoring the state of the lane change controller 120.

Next, the lane change controller 120 determines whether the vehicle M has moved in the direction opposite to the side where the lane change is performed, regardless of the operation of the driver (step S5). Further, at this point, the steering force for the lane change has not yet been output, and the vehicle M is in a state where it can move in the direction opposite to the side where the lane change is performed due to disturbances such as cross-winds, road inclinations (cants), bumps, or the like.

The determination that “the vehicle M has moved in the direction opposite to the side where the lane change is performed regardless of the operation of the driver” is made based on the following judgment conditions. For example, in a state in which the steering torque sensor 40 does not detect a torque of a predetermined value or more in the direction opposite to a side where the lane change is performed, the lane change controller 120 may determine that (A) “the vehicle M has moved in the direction opposite to the side where the lane change is performed” when the reference point of the vehicle M comes in contact with the road division line in the direction opposite to the side where the lane change is performed, (B) “the vehicle M has moved in the direction opposite to the side where the lane change is performed” when the distance between the reference point of the vehicle M and the road division line in the direction opposite to the side where the lane change is performed becomes less than a determined distance, and (C) “the vehicle M has moved in the direction opposite to the side where the lane change is performed” when a time to collision (TTC) between the reference point of the vehicle M and the road division line in the direction opposite to the side where the lane change is performed becomes less than a threshold, and may perform determination using another method similar to these. Further, when the steering torque sensor 40 detects a torque equal to or greater than the predetermined value, if an override operation is performed by the driver, the lane change control itself is canceled.

When the vehicle M has moved in the direction opposite to the side where the lane change is performed, the processing advances to step S10. This will be described below. When the vehicle M has not moved in the direction opposite to the side where the lane change is performed, the lane change controller 120 determines whether a reference time has elapsed since the lane change control started (step S6). When the reference time has not elapsed since the lane change control started, the processing is returned to step S5.

When the reference time has elapsed since the lane change control started, the lane change controller 120 outputs a steering force to the steering device 220 to change the lane (step S7). The lane change controller 120 generates, for example, a plan of a target lateral position in order to change the lane smoothly, and causes the steering device 220 to output the steering force calculated as a result of the feedback control for making the vehicle M to reach the target lateral position on time.

Next, the lane change controller 120 determines whether a cancel condition of the lane change control is established (step S8). The cancel condition is, for example, when the predetermined time has elapsed or the vehicle M has moved a predetermined distance from the start of the lane change control. When the cancel condition is established, the processing advances to step S10.

When the cancel condition is not established, the lane change controller 120 determines whether the lane change is terminated (step S9). The lane change controller 120 determines that the lane change is terminated, for example, when the entire or the center of gravity of the vehicle M moves to the adjacent lane. When it is determined that the lane change is terminated, the vehicle control device 100 returns to the state it was in at the start of this flowchart.

When it is determined that the vehicle M has moved in the direction opposite to the side where the lane change is performed in step S5 and when it is determined that the cancel condition has been established in step S8, the lane change controller 120 instructs the deviation suppression controller 110 to switch to the ON state (step S10). Further, such processing may be performed autonomously by the deviation suppression controller 110 by monitoring the state of the lane change controller 120. Then, the lane change controller 120 stops the operation of the direction indicator 50 while cancelling the lane change control (step S11).

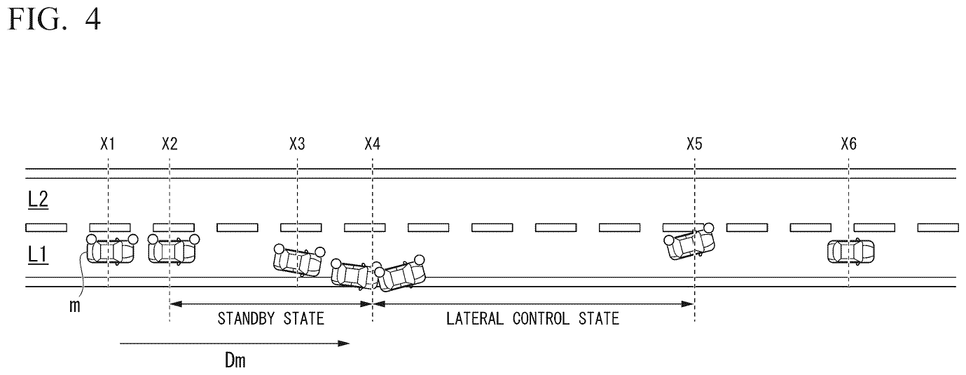

FIG. 4 is a view showing an example of an operation in a comparative example without the function of the present invention. A vehicle m in the comparative example does not have a function of “suppressing the deviation of the vehicle from the traveling lane when the vehicle moves in the opposite direction to the adjacent lane at the lane change destination regardless of the operation of the driver,” and is configured so that deviation suppression control is in the OFF state from starting of the lane change control until cancellation thereof. In the drawings, Dm indicates a direction of advance of the vehicle m of the comparative example, L1 indicates a traveling lane, and L2 indicates an adjacent lane. At point X1, the driver performs a starting operation in response to the turn signal lever, and at point X2, the initiation condition is satisfied. At point X3, the vehicle m begins to experience disturbance, and at point X4, it comes into contact with a road division line in the direction opposite to the side where the lane change is performed. In the vehicle m of the comparative example, no special measures have been taken to prevent this, so the lane change control continues. However, due to the disturbance, the lane change control is delayed, and at point X5, the cancel condition is finally established, and the lane change control is stopped. When such control is performed, there is a concern that a driver may feel discomfort because they have to wait for a long time in a state where the lane change control is not executed, and the lane change is not actually performed in the end. In addition, there is also concern that the direction indicator will continue to operate even though the lane change is not being performed, which may confuse drivers of nearby vehicles.

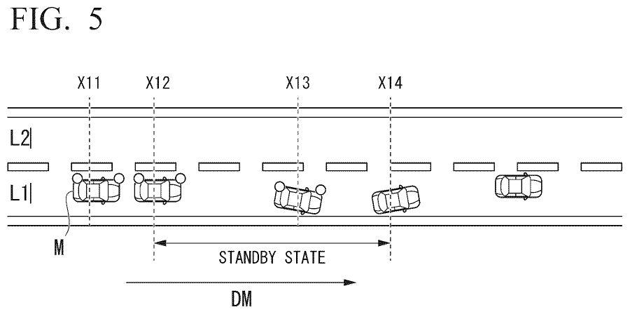

On the other hand, FIG. 5 is a view showing an example of an operation in the vehicle control device 100 of the first embodiment. In the drawings, DM indicates a direction of advance of the vehicle M of the embodiment. At point X11, the driver performs a starting operation in response to the turn signal lever, and at point X12, the starting condition is established. At point X13, the vehicle M begins to experience disturbance, and at point X14, it comes into contact with a road division line in the opposite direction to the lane change direction. Here, as described above, the deviation suppression controller 110 returns to the ON state and lane change control is stopped, so the vehicle control device 100 can quickly return to the state from before the lane change control started. As a result, it is possible to respond appropriately when an event occurs that is not dependent on the operation of the driver.

According to the above-mentioned first embodiment, it is possible to respond appropriately when an event occurs that is not dependent on the operation of the driver.

### Second Embodiment

Hereinafter, a second embodiment will be described. When the lane change control is started, the deviation suppression controller 110 does not go into the OFF state, but the vehicle control device 100 in the second embodiment shifts to a single-sided operation mode in which it operates only on the road division line in the direction opposite with respect to the adjacent lane of the lane change destination, among the road division lines on either side of the traveling lane. That is, the deviation suppression controller 110 operates for the road division lines on both sides of the traveling lane when lane change control is not being performed (normal mode), and operates only for the road division line in the opposite direction with respect to the adjacent lane of the lane change destination, among the road division lines on both sides of the traveling lane, when the lane change control is being performed.

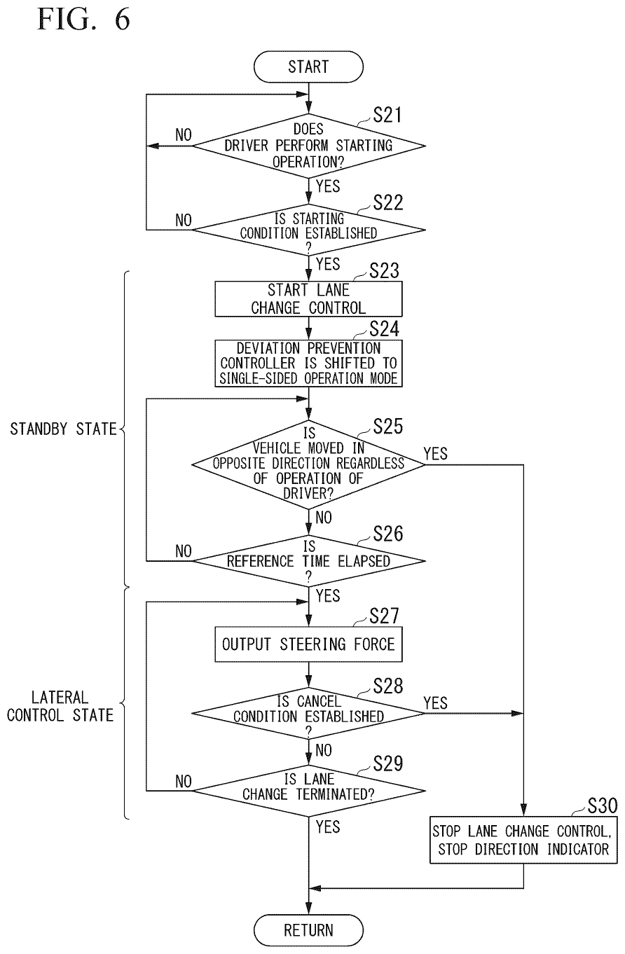

FIG. 6 is a view showing an example of a flow of processing executed by the lane change controller 120 of the second embodiment. First, the lane change controller 120 determines whether the driver has performed a starting operation with respect to the turn signal lever 30 (step S21). When it is detected that the driver has performed the starting operation with respect to the turn signal lever 30, the lane change controller 120 determines whether the starting condition of the lane change control is established (step S22). When a negative determination result is obtained in either step S21 or S22, the processing is returned to step S21. Further, when the turn signal lever 30 is started, the direction indicator 50 starts to operate in tandem.

When the initiation condition of the lane change control is established, the lane change controller 120 starts the lane change control (step S23). In addition, the lane change controller 120 instructs the deviation suppression controller 110 to shift to a single-sided operation mode (step S24). Further, such processing may be performed autonomously by the deviation suppression controller 110 by monitoring the state of the lane change controller 120.

Next, the lane change controller 120 determines whether the vehicle M has moved in the direction opposite to the side where the lane change is performed, regardless of the operation of the driver (step S25). Further, at this point, the steering force for the lane change has not yet been output, and the vehicle M is in a state where it can move in the direction opposite to the side the lane change is performed due to disturbances such as cross-winds, road inclinations (cants), and bumps. The determination that “the vehicle M moved in the direction opposite to the side where the lane change is performed regardless of the operation of the driver” is the same as in the first embodiment.

When the vehicle M has moved in the direction opposite to the side where the lane change is performed, the processing advances to step S30. This will be described below. When the vehicle M has not moved in the direction opposite to the side where the lane change is performed, the lane change controller 120 determines whether a reference time elapses since the lane change control is started (step S26). When the reference time has not elapsed since the lane change control is started, the processing is returned to step S25.

When the reference time elapses since the lane change control has been started, the lane change controller 120 causes the steering device 220 to output a steering force for a lane change (step S27). The lane change controller 120 generates, for example, a plan for a target lateral position to change a lane smoothly, and causes the steering device 220 to output a steering force calculated as a result of feedback control for making the vehicle M to reach the target lateral position on time.

Next, the lane change controller 120 determines whether the cancel condition of the lane change control is established (step S28). The cancel condition is, for example, when a predetermined time has elapsed or the vehicle M has moved a predetermined distance from the start of the lane change control. When the cancel condition is established, the processing advances to step S30.

When the cancel condition is not established, the lane change controller 120 determines whether the lane change is terminated (step S29). The lane change controller 120 determines that the lane change is terminated, for example, when the entire or the center of gravity of the vehicle M has moved to the adjacent lane. When it is determined that the lane change is terminated, the vehicle control device 100 returns to the state at the start of the flowchart. The deviation suppression controller 110 also shifts to a normal mode.

When it is determined that the vehicle M has moved in the direction opposite to the side where the lane change is performed in step S25 and when it is determined that the cancel condition is established in step S28, the lane change controller 120 stops the lane change control and stops the operation of the direction indicator 50 (step S30). After that, the deviation suppression controller 110 shifts to the normal mode.

According to the above-mentioned second embodiment, the same effects as in the first embodiment can be exhibited.

The above-mentioned embodiment can be expressed as follows.

A vehicle control device including:
a storage medium configured to store instructions readable by a computer (computer-readable instructions); and
one or more processors connected to the storage medium,
the one or more processor executing the instructions readably by the computer to: (the processor executing the computer-readable instructions to:)
perform lane change control of causing the vehicle to change a lane autonomously from a traveling lane along which the vehicle travels to a lane adjacent to the traveling lane, and
suppress deviation of the vehicle from the traveling lane when the vehicle has moves in a direction opposite to the adjacent lane regardless of the operation of an occupant in the vehicle after the lane change control has been started.

While preferred embodiments of the invention have been described and illustrated above, it should be understood that these are exemplary of the invention and are not to be considered as limiting. Additions, omissions, substitutions, and other modifications can be made without departing from the scope of the present invention. Accordingly, the invention is not to be considered as being limited by the foregoing description, and is only limited by the scope of the appended claims.

What is claimed is:

1. A vehicle control device comprising:
a deviation suppression controller configured to suppress deviation of a vehicle from a traveling lane along which the vehicle travels; and
a lane change controller configured to perform lane change control of causing the vehicle to autonomously change a lane from the traveling lane to a lane adjacent to the traveling lane,
wherein the deviation suppression controller suppresses deviation of the vehicle from the traveling lane when the vehicle moves in a direction opposite to the adjacent lane regardless of an operation of an occupant in the vehicle after the lane change control has been started.

2. The vehicle control device according to claim 1, wherein the deviation suppression controller is set to an OFF state when the lane change control has been started, and is set to an ON state when the vehicle moves in the opposite direction with respect to the adjacent lane after the lane change control has been started, regardless of the operation of the occupant in the vehicle.

3. The vehicle control device according to claim 1, wherein the deviation suppression controller is set to an OFF state when the lane change control has been started, and is maintained in the OFF state when the vehicle moves to the adjacent lane after the lane change control has been started.

4. The vehicle control device according to claim 1, wherein the deviation suppression controller becomes in the ON state when the vehicle reaches a road division line in the opposite direction to the adjacent lane, regardless of the operation of the occupant in the vehicle, after the lane change control has been started.

5. The vehicle control device according to claim 1, wherein the lane change control is canceled when a predetermined time elapses from a starting time point or the vehicle has moved a predetermined distance, and
the deviation suppression controller becomes an ON state from an OFF state when the lane change control has been canceled.

6. The vehicle control device according to claim 1, wherein the lane change control is a control in which steering control of the vehicle is started at a timing after a reference time has been elapsed from a timing when a starting condition has been established, and
the deviation suppression controller suppresses deviation of the vehicle from the traveling lane when the vehicle has moved in the opposite direction with respect to the adjacent lane regardless of an operation of an occupant in the vehicle until a reference time elapses from a timing when a starting condition of the lane change control was established.

7. The vehicle control device according to claim 1, wherein, when the lane change control is not performed, the deviation suppression controller suppresses deviation of the vehicle from the traveling lane with respect to road division lines on both sides of the traveling lane, and
when the lane change control is performed, the deviation suppression controller suppresses the deviation of the vehicle from the traveling lane with respect to the road division line in the opposite direction to the adjacent lane among the road division lines on both sides of the traveling lane.

8. The vehicle control device according to claim 1, wherein the lane change controller operates a direction indicator when the lane change control is performed, and
after the lane change control has been started and when the deviation suppression controller suppresses the deviation of the vehicle from the traveling lane as the vehicle moves in the opposite direction to the adjacent lane, regardless of an operation of an occupant in the vehicle, the operation of the direction indicator is stopped.

9. A vehicle control method of causing a vehicle control device to execute:
processing of performing lane change control of causing a vehicle to autonomously change a lane from a traveling lane along which the vehicle travels to a lane adjacent to the traveling lane; and
processing of suppressing deviation of the vehicle from the traveling lane when the vehicle moves in an opposite direction with respect to the adjacent lane, regardless of an operation of an occupant in the vehicle, after the lane change control has been started.

10. A computer-readable non-transient storage medium on which program is stored to cause a processor of a vehicle control device to execute:
processing of performing lane change control of causing a vehicle to autonomously change a lane from a traveling lane along which the vehicle travels to a lane adjacent to the traveling lane; and
processing of suppressing deviation of the vehicle from the traveling lane when the vehicle moves in an opposite direction with respect to the adjacent lane, regardless of an operation of an occupant in the vehicle, after the lane change control has been started.
